(19) United States
(12) Patent Application Publication
(10) Pub. No.: US 2017/0317547 A1
(43) Pub. Date: Nov. 2, 2017

(54) STATOR FOR AN ELECTRICAL MACHINE AND AN ELECTRICAL MACHINE HAVING SUCH A STATOR

(71) Applicant: Robert Bosch GmbH, Stuttgart (DE)

(72) Inventor: Peter Bolz, Buehl (DE)

(21) Appl. No.: 15/499,039

(22) Filed: Apr. 27, 2017

(30) Foreign Application Priority Data
Apr. 29, 2016 (DE) 10 2016 207 338.9
Nov. 22, 2016 (DE) 10 2016 223 003.4

(51) Int. Cl. H02K 3/28; H02K 1/14

(52) U.S. Cl. CPC H02K 3/28; H02K 1/146

(57) ABSTRACT

A stator for an electrical machine having a stator body which has radial stator teeth with windings. At least some of the windings are interconnected to form a circuit strand. At least two part-motors within the stator contain in each case a part of the circuit strand.

### BACKGROUND OF THE INVENTION

Electrical machines are known which have a stator on which stator teeth are arranged. The stator teeth are carriers of electrical windings. The electrical windings are wound onto the stator teeth. The windings are connected to one another in such a manner that they form circuit strands. The circuit strands are a winding arrangement, overall. In the electrical machines of the prior art, only one motor is provided by the winding arrangement. If this winding arrangement fails, the entire electrical machine fails.

### SUMMARY OF THE INVENTION

The present invention has the advantage that at least two part-motors are formed in the electrical machine. The part-motors are provided by the winding arrangement. In the case of a failure of one part-motor, there is at least a second part-motor provided for a continuing operation of the electrical machine. Thus, the operation of the electrical machines is maintained by a part-motor even in the case of such a disturbance. The stator body comprises radial stator teeth. On the radial stator teeth, an electrical winding is arranged in each case. Each stator tooth carries one winding. The windings form the winding arrangement. Some of the windings are connected together to form a part-motor whilst the remaining windings are interconnected to form at least one second part-motor. In this context, the part-motors are identical which means that for each part-motor, an equal number of preferably identical windings are used. In addition, the windings are distributed evenly on the stator teeth. Since the part-motors are identical with respect to one another, windings of one part-motor can be allocated to windings of the other part-motor. Windings which are interconnected in an identical circuit strand within the winding arrangement are allocated to one another, the circuit strand being part of each part-motor.

In an advantageous development of the invention, the windings of a circuit strand are arranged offset with respect to one another by at least three stator teeth. This achieves an optimum distribution of energy density for each part-motor since the windings have an ideal spacing from one another.

Advantageously, the part-motors of the winding arrangement are designed as delta circuit or star circuit. A delta circuit or a star circuit is characterized by circuit strands which are connected in parallel with one another. The circuit strands have at least two windings in this arrangement. A circuit strand having windings has a node with a further circuit strand with windings. In the case of the delta circuit, electrical energy is supplied or removed, respectively, starting from this node. In the case of the star circuit, all three circuit strands come together in one node whilst in the case of the delta circuit, two adjacent circuit strands have in each case one node. A delta circuit, therefore, has three nodes.

The advantageous continuation of the present invention has two parallel-connected circuit paths per circuit strand. This means that a circuit strand is constructed of in each case two parallel-connected circuit paths in which in each case at least one winding is arranged. The windings within a circuit strand, and therefore also within a circuit path, are offset with respect to one another by three stator teeth. The circuit paths come together with circuit paths of an adjacent circuit strand in one node. This forms a delta circuit or a star circuit which is doubled. The delta circuit or the star circuit, respectively, has a parallel-connected similar or identical delta circuit or star circuit which are connected in parallel with one another at the nodes. Such an advantageous continuation has the advantage that in the case of a failure of a parallel-connected part-motor in the winding arrangement, the remaining parallel-connected part-motors are still operational. In addition, it is also possible to switch off only one winding without a significant loss of efficiency of the electrical machine being noticeable.

A circuit strand suitably has four windings overall, two windings being connected in series per circuit path. This provides for a compact construction.

If the stator has 6 or 12 or 18 stator teeth, it is possible to provide an electrical machine which produces a slight shaft torque. Shaft torque is understood to be the periodic wave-like behavior of the torque of the electrical machine during a rotation of the motor.

With respect to the installation space, it is very efficient to let a part of the winding wire run along the outer circumference of the stator body in the circumferential direction. In this context, the parts of the winding wire are arranged axially offset with respect to one another on an outer circumference of the stator. Thus, the wires can be arranged axially adjacent to one another on the outer circumference without building up by more than one wire thickness toward the outside in the radial direction which leads to a saving in installation space. The wires run next to one another and do not cross one another.

The stator has an insulation mask on the stator body. The insulation mask is used for insulating the windings against the stator body so that the windings are not wound directly onto the winding teeth but onto the insulation mask. The insulation mask is arranged on the stator teeth. This results in a mechanical and an electrical isolation between the stator body and the winding. This forms at least one insulation mask. The insulation mask comprises guides for the winding wires in order to conduct the winding wires from one winding within the stator toward the outside onto the outer circumference of the stator.

In particular, the guides are formed between continuations which extend axially from the stator and form a part of an outer circumferential area. Preferably, two winding wires are arranged next to one another on the outer circumferential area. Thus, the winding wires can be conducted along on the outer circumferential area. This leads to a robust and installation-space-saving embodiment of the device.

The windings of a circuit path are suitably wound from one circuit strand continuously with the same winding wire to a part-motor. If a part-motor is wound with a single winding wire, it is possible, for example in the case of two part-motors, to use two winding wires for the winding arrangement. Thus, a part-motor is constructed of in each case one circuit path from each of the circuit strands. In other words, from each circuit strand, a circuit path is used for building up a part-motor. If then, for example, two circuit paths are formed per circuit strand, two part-motors can be constructed.

The part-motors are connected in parallel with bridges. In this arrangement, the bridges are formed at the nodes. The bridges can in this case be made from stamped grid parts. These stamped grid parts have cutting clamps here into which the winding wires are clamped and are contacted at the same time by cutting. The cutting clamps contact the winding wire in that they cut through the insulating layer of the winding wire.

### BRIEF DESCRIPTION OF THE DRAWINGS

In the drawings:

FIG. 1 a) shows a stator body with coils arranged thereon in a perspective view,

FIG. 1 b) shows a top view of a stator body having coils,

FIG. 2 shows a winding arrangement having two part-motors which are arranged on a stator,

FIG. 3 shows a diagrammatic winding arrangement having two part-motors,

FIG. 4 shows an electrical machine having a stator according to the invention,

FIG. 5 shows a stamped-bending part as cutting clamp for a wire.

### DETAILED DESCRIPTION

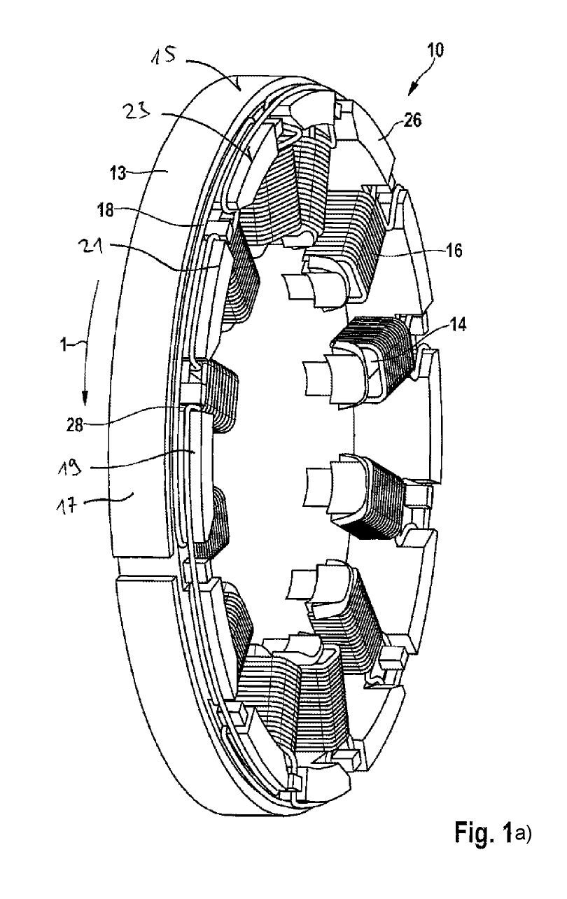

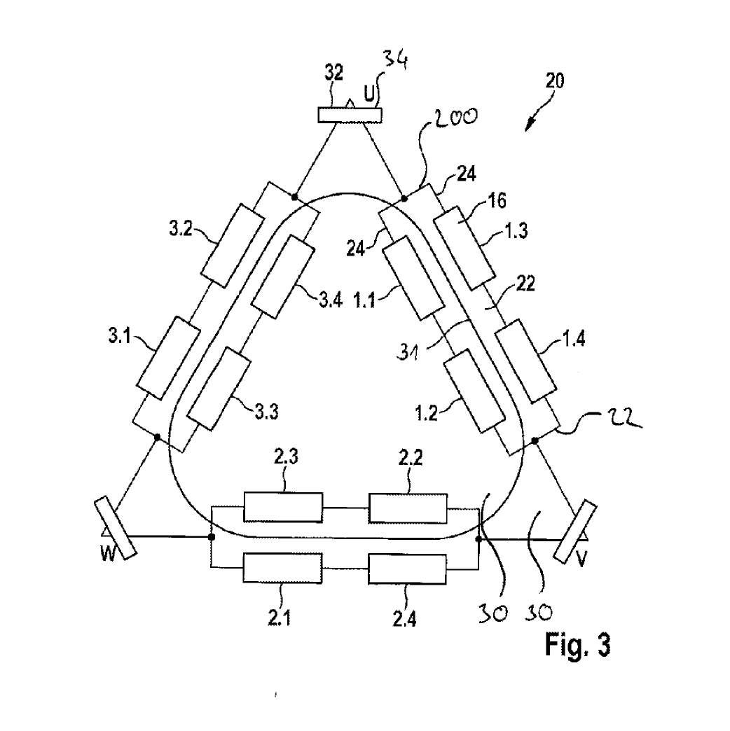

FIG. 1 a) shows a stator 10 for an electrical machine 12. The electrical machine 12 is presented in FIG. 4 in which the stator 10 is arranged. The stator 10 comprises a stator body 13 which has a yoke and stator teeth 14 extending radially from the yoke. The stator teeth 14 extend perpendicularly here with respect to the circumferential direction 1 radially inward. On the stator teeth 14, exactly one electrical winding 16 is arranged in each case. The windings 16 form a winding arrangement 20 having two identical part-motors 30. In this context, the winding arrangement 20 is wound from winding wire 18. The part-motors 30 are arranged separately from one another on different stator teeth 14.

Each sub-motor 30 is preferably wound from a separate winding wire 18. In this context, the windings 16 of the various part-motors 30 which are in each case allocated to one another are arranged offset with respect to one another by at least three stator teeth 14.

FIG. 1 a) also shows that the winding wires 18 are run in the circumferential direction 1 of the stator body 13 on the outer circumference 15. The winding wires 18 rest on the same outer circumferential area 23 of the stator body 13. In this way, the winding wires 18 can be adjacent to one another in the axial direction.

In addition, it can be seen that the windings 16 are arranged on an insulating mask 26. The insulating mask 26 is constructed of two parts and arranged on the stator body 13 of the stator 10. In FIG. 1 a), only one half of the insulating mask 26 is shown on the stator 10. The second lower half is not reproduced. The insulating mask 26 is stuck axially onto the stator 10. The insulating mask 26 has guides 28 for the winding wires 18. The guides 28 for the winding wires 18 are arranged in the area of the outer circumference 15 of the insulating mask 10.

The outer circumference 15 is subdivided into two axially adjoining sections 17, 19, wherein a section 17 runs around the stator 10 in a closed manner and is radially farther outside than the second section 19. The second section 19 is formed of radially external axial continuations 21. The axial continuations 21 are arranged between two teeth 14 in each case. The continuations 21 form a radially outwardly directed circumferential area 23 in the area of the outer circumference 15. Between the continuations 21, guides 28 are formed. The winding wires 18 are conducted by the guides 28 from the interior of the stator 10 to the outer circumferential area 23 in order to be arranged there next to one another with respect to the axial direction on the circumferential area 23 of the second section 19. In this context, it is always only two winding wires 18 which are conducted axially next to one another along the circumferential area 23 in the circumferential direction 1. One of these winding wires 18 in each case belongs to one part-motor 30.

On the stator body 13, the winding wire 18 is wound as can be seen from FIG. 1 b). The stator 10 is constructed of tooth segments 27 which provide the stator teeth 14 for the windings 16. The windings 16 of a part-motor 30 are wound with a continuous winding wire 18 without interruption. Two separate winding wires 18 are wound through in the winding arrangement 20 since the winding arrangement 20 contains two part-motors 20.

In the embodiment of FIG. 1 b) each part-motor is constructed as a delta circuit 200. Each delta circuit 200 has three nodes U, V, W which are provided by in each case one pair of cutting clamps 34. Each cutting clamp 34 represents a part-node U1, U2, V1, V2, W1, W2. The first part-motor 30 comprises the part-nodes U1, V1, W1 and the second part-motor 30 comprises the part-nodes U2, V2, W2.

The winding 1.1 is directly adjacent to part-node U1 of the first part-motor 30 in FIG. 1 b). A wire start 26 of the winding 1.1 is clamped into the cutting clamp 34 of the part-node U1. On the other side of the winding 1.1, the winding 1.2 is wound from a part of the remaining winding wire 18 which is done clockwise starting from winding 1.1 after three stator teeth 14. Between the directly adjacent windings 1.2 and 2.2, a loop 25 is formed on which the part-node V1 is produced by a cutting clamp 34. In FIG. 1 b), the loop 25 is shown diagrammatically. The loop 25 can protrude radially at the stator 10 or be dimensioned to be so short that it runs directly along the cutting clamp 34. Similarly, the wire starts 26 can protrude out radially at the stator 10 in the same way or be dimensioned to be so short that they do not significantly protrude over the cutting clamp 34. After the winding of the winding 2.2, the winding wire 18 is continued uninterrupted in the clockwise direction for three stator teeth 14 in order to wind the winding 2.3. From the winding 2.3, a further loop 25 is formed which leads to the directly adjacent winding 3.3. From this winding 3.3, the last part of the winding wire 18 is conducted to the winding 3.4 which, in turn, is directly adjacent to the winding 1.1. The wire end 26, like the wire start 26, is clamped into a common cutting clamp 34 so that the first part-motor 30 is wound by a continuous winding wire 18. In this context, the part-motor 30 extends over the entire circumference of the stator 10.

This winding scheme is performed in the same way for the second part-motor 30, the starting point being at the part-node U2 which is rotated by 180° compared with U1 along the circumferential direction 1 of stator 10. In this context, the winding 1.4 follows, starting from the first winding 1.3 after three stator teeth 14. Starting from the winding 2.4, the winding 2.1 likewise follows after three stator teeth 14. The same applies to the windings 3.1 and 3.2. The windings 16 can also be mounted counterclockwise.

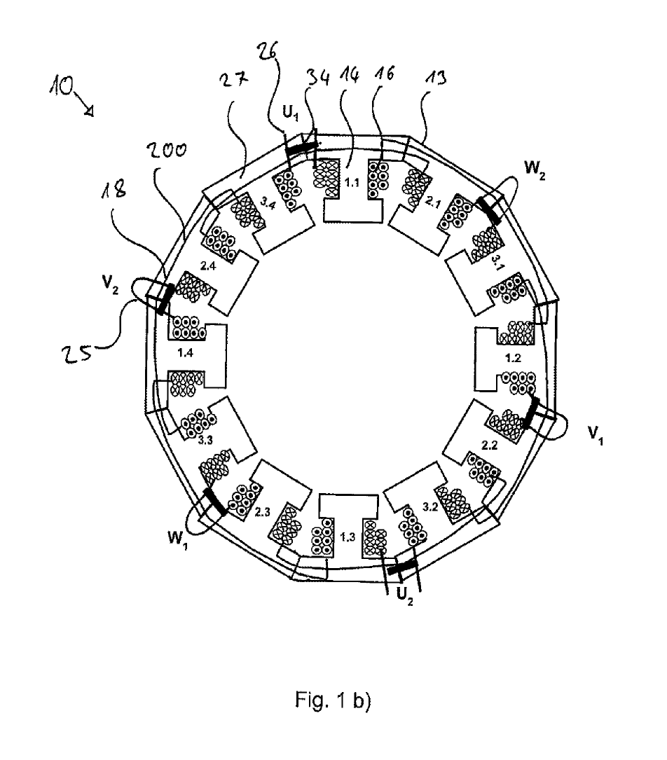

In FIG. 2, a stator 10 is shown which diagrammatically has the winding arrangement 20 of FIGS. 1 a) and b). The winding arrangement 20 is a dual delta circuit 200. Thus, two delta circuits 200 are shown, each being a part-motor 30. The delta circuits 200 are rotated by 180° with respect to one another in the circumferential direction 1.

The part-motors 30 which are shown as delta circuits 200 are constructed identically with respect to one another. In this context, each part-motor 30 in FIG. 2 represents an equilateral triangle, the two equilateral triangles being rotated by 180° with respect to one another.

Four windings 16 in each case form a circuit strand 22. In this context, the windings 1.1, 1.2, 1.3 and 1.4 are interconnected in a circuit strand 22 and the windings 2.1, 2.2, 2.3 and 2.4 are interconnected in a further parallel-connected circuit strand 22. The windings 3.1, 3.2, 3.3 and 3.4 are arranged in a third circuit strand 22 connected in parallel with the two previous ones.

A circuit strand 22 consists of two circuit paths 24 which are connected in parallel with one another. A circuit path 24 comprises two series-connected windings 16. Each of these circuit paths 24 of a circuit strand 22 belongs to one of the two part-motors 30. The parallel-connected circuit paths 24 thus form in each case one circuit strand 22 which, in turn, are connected in parallel with other circuit strands 22 and thus form the entire winding arrangement 20. Adjacent windings 16 within a circuit strand 22 are offset with respect to one another by three stator teeth 14. Thus, windings 16 within a circuit path 24 are also offset with respect to one another by three stator teeth 14 in each case. This means that, for example starting from the stator tooth 14 of the winding 1.1, the winding 1.2 follows after three stator teeth 14 and subsequently, the winding 1.3 is arranged after three stator teeth and finally the winding 1.4 is likewise wound after three stator teeth 14. This can be transferred analogously to each circuit strand 22.

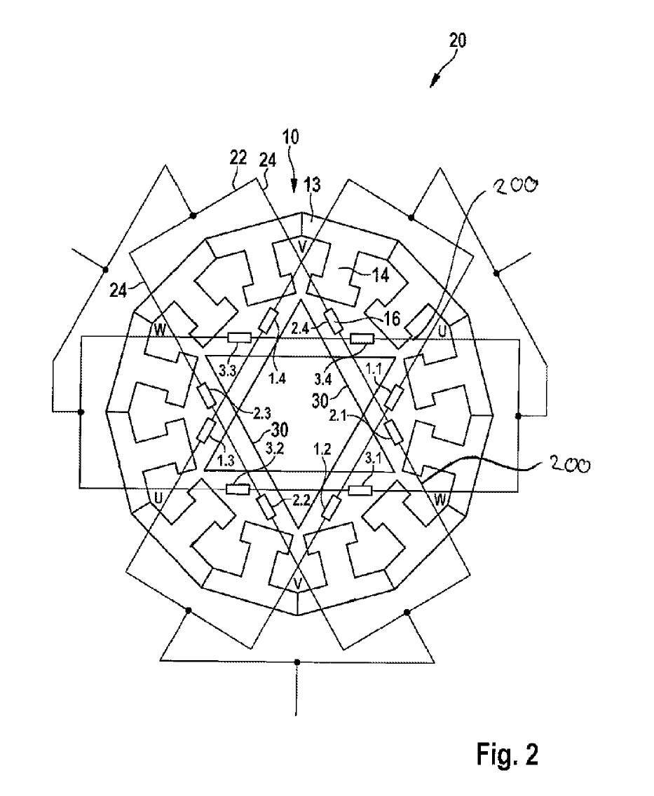

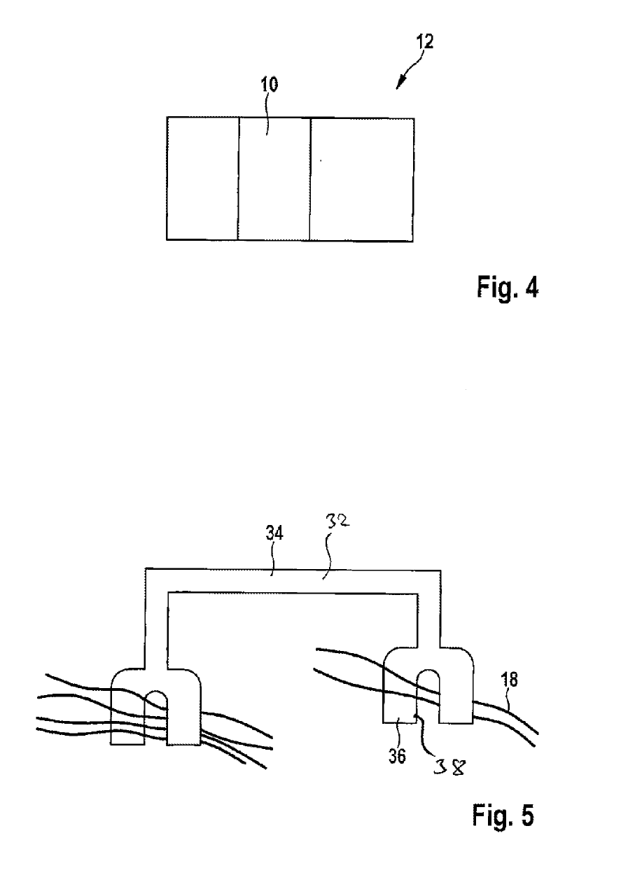

In FIG. 3, a diagrammatic winding arrangement 20 of windings 16 is shown in a delta circuit 200. By means of the circuit strands 22 having two circuit paths 24, a dual delta circuit is implemented. The circuit diagram from FIG. 3 has the two part-motors 30 here which are separated from one another by a diagrammatic triangular line 31. Each part-motor 30 is constructed by the circuit paths 24 of the circuit strands 22. At the nodes U, V and W, the circuit strands 22 are connected to one another by bridges 32. The bridges are provided by stamped-bent cutting clamps 34 as is shown in FIG. 5.

The electrical machine 12 from FIG. 4 contains the stator body 10 according to the invention. In this context, the stator body is enclosed by a housing of the electrical machine 12.

In FIG. 5, stamped-bending parts 36 are shown which are attached to the stator 10 and have cutting clamps 34 into which the winding wires 18 are clamped. By this means, the part-nodes U1, U2, V1, V2, W1, W2 can be generated. These stamped-bending parts 36 are bridges 32 and form a bridge 32 between adjacent circuit strands 22. The bridge 32 has here two cutting clamps 34 into which winding wires 18 are placed. The cutting clamps 34 here contact the conductive material of the winding wires 18. This also takes place when the winding wires 18 are provided with an insulating coating because the cutting clamp 36 has blades 38 which cut through the insulating layer.

1. A stator (10) for an electrical machine (12), the stator having a stator body (13) which has radial stator teeth (14) with windings (16), at least some of the windings (16) being arranged to form a circuit strand (22), wherein the stator (20) has at least two part-motors (20) which contain in each case a part of the circuit strand (22).

2. The stator (10) according to claim 1, characterized in that the windings (16) of the circuit strand (22) are offset with respect to one another by at least three stator teeth (14).

3. The stator (10) according to claim 1, characterized in that a winding arrangement (20) of the stator is a delta circuit (200) or a star circuit of the windings (16), the circuits (200) having in each case three circuit strands (22) which comprise in each case two parallel-connected circuit paths (24).

4. The stator (10) according to claim 1, characterized in that in one circuit path (24) two windings (16) are connected in series.

5. The stator (10) according to claim 1, characterized in that the stator (10) has six, twelve or eighteen stator teeth (14).

6. The stator (10) according to claim 1, characterized in that a part of a winding wire (18) extends in a circumferential direction (1) in an area of an outer circumference (24) of the stator body (13), further parts of the winding wire (18) extending axially offset thereto in the circumferential direction (1).

7. The stator (10) according to claim 6, characterized in that the windings (16) are wound onto at least one insulating mask (26), the insulating mask (26) being arranged on the stator body (13) and the stator teeth (14), the insulating mask (26) having guides (28) for winding wires (18) which are arranged in the area of the outer circumference (24).

8. The stator (10) according to claim 7, characterized in that the insulating mask (26) has axial continuations (21) which form a radially outwardly directed circumferential area (23) in the area of the outer circumference (24) against which the winding wire (18) rests.

9. The stator (10) according to claim 7, characterized in that the guides (28) are formed between the continuations (21).

10. The stator (10) according to claim 7, characterized in that on the circumferential area (23), two winding wires (18) are guided along in the circumferential direction (1).

11. The stator (10) according to claim 1, characterized in that the windings (16) of a circuit path (24) of a circuit strand (22) are wound continuously with an identical winding wire (18) to form a part-motor (30) so that a circuit path (24) of a circuit strand (22) is in each case interconnected in a part-motor (30).

12. The stator (10) according to claim 1, characterized in that at least two part-motors (30) are wound and are connected in parallel with bridges (32).

13. The stator (10) according to claim 12, characterized in that the bridges are stamped-bending parts (36).

14. The stator (10) according to claim 13, characterized in that the stamped-bending parts (36) have cutting clamps (34) into which the winding wire (18) can be contacted and clamped.

15. The stator (10) according to claim 1, characterized in that in one circuit path (24) two windings (16) are connected in series so that a circuit strand (22) has four windings (16).

16. The stator (10) according to claim 12, characterized in that the bridges are stamped-bending parts (36) arranged as a stamped grid at the stator (10).

17. An electrical machine (12) having a stator (10) according to claim 1.
